(19) United States
(12) Patent Application Publication
(10) Pub. No.: US 2010/0272471 A1
(43) Pub. Date: Oct. 28, 2010

(54) ELECTROPHOTOGRAPHIC TONER AND ELECTROPHOTOGRAPHIC IMAGE FORMING APPARATUS USING THE SAME

(75) Inventors: Woo Young Yang, Daejeon-City (KR); Keon II Kim, Daejeon-City (KR); Dae II Hwang, Daejeon-City (KR); Jae Bum Park, Daejeon-City (KR); II Sun Hwang, Daejeon-City (KR); Jun-Hee Lee, Daejeon-City (KR); Jae Kwang Hwang, Daejeon-City (KR); Dong Won Kim, Daejeon-City (KR); Duck Kyun Ahn, Daejeon-City (KR)

Correspondence Address: Nixon Peabody LLP, P.O. Box 60610, Palo Alto, CA, 94306, US

(73) Assignee: SAMSUNG FINE CHEMICALS CO., LTD., ULSAN-CITY (KR)

(21) Appl. No.: 12/747,511

(22) PCT Filed: Dec. 17, 2008
(86) PCT No.: PCT/KR2008/007488

§ 371 Date: Jun. 10, 2010

(30) Foreign Application Priority Data
Dec. 18, 2007 (KR) 10-2007-0133703

(51) Int. Cl. G03G 15/06; G03G 9/08; G03G 9/087; G03G 9/09

(52) U.S. Cl. 399/222; 430/108.6

(57) ABSTRACT

Provided are an electrophotographic toner and an electrophotographic image forming apparatus using the same. The electrophotographic toner includes: parent toner particles including a binder resin, a colorant, a releasing agent, and a charge control agent; and barium titanate external additives having an average primary particle diameter in the range of about 50 to about 150 nm, an average shape factor (SF1) in the range of about 100 to about 120, a shape factor in the range of about 0.96 to about 1, and an aspect ratio in the range of about 0.89 to about 1, and added to the surface of the parent toner particles.

### CROSS-REFERENCE TO RELATED PATENT APPLICATION

This application is a national phase of International Application No. PCT/KR2008/007488, entitled “ELECTROPHOTOGRAPHIC TONER AND ELECTROPHOTORAPHIC IMAGE FORMING APPARATUS USING THE SAME”, which was filed on Dec. 17, 2008, and which claims priority to Korean Patent Application No. 10-2007-0133703, filed on Dec. 18, 2007, in the Korean Intellectual Property Office, the disclosure of which is incorporated herein in its entirety by reference.

### BACKGROUND OF THE INVENTION

1. Technical Field

An embodiment of the present invention relates to an electrophotographic toner and an electrophotographic image forming apparatus using the same, and more particularly, to an electrophotographic toner having excellent image density and excellent transferring efficiency, in which external additives are not detached from the surface of a parent toner particle even after printing for a long period of time, due to high charge stability, and an electrophotographic image forming apparatus using the same.

2. Background Art

Generally, electrophotographic image forming apparatuses include a developing device including a toner cartridge and a photoreceptor, and a transferring unit. In electrophotographic image forming apparatuses, a visible image is formed by exposing a uniformly charged photoreceptor to light to form an electrostatic latent image, attaching toner to the electrostatic latent image to form a toner image, transferring the toner image to a printing medium, and fixing the toner image. The electrophotographic image forming apparatus may be a laser printer, a facsimile, a photocopier, or the like.

Dry toner may be classified into mono-component toner and two-component toner according to charging types of toner particles. Dry toner may also be classified into magnetic toner and non-magnetic toner according to methods of transferring the charged toner particles to a region on which an electrostatic latent image is formed. The mono-component toner is charged by friction among toner particles or friction between toner particles and doctor blade. The two-component toner is charged by friction between toner particles and carrier particles by mixing non-magnetic toner particles and magnetic carrier particles. In addition, non-magnetic toner is transferred by mobility of toner particles without using magnetic force, and magnetic toner is transferred by magnetic force, which is induced by mixing toner particles with a magnetic material such as ferrite.

FIG. 1 schematically illustrates a non-contact developing type electrophotographic image forming apparatus 4 using a non-magnetic, mono-component electrophotographic toner, which operates according to the following process.

A charging bias voltage is applied to a charging roller 2 in order to uniformly charge the surface of a photoreceptor 1.

A light exposure signal 3 corresponding to image data of colors such as cyan (C), magenta (M), yellow (Y), and black (K) is irradiated to the photoreceptor 1 in response to an electrical signal.

Toner 8 is supplied to a developing roller 5 via a supply roller 6 formed of an elastic member such as polyurethane foam or sponge.

The toner 8 supplied to the developing roller 5 reaches a contact point of a toner doctor blade 7 and the developing roller 5 as the developing roller 5 rotates. The toner doctor blade 7 is formed of an elastic member such as metal or rubber. The toner 8 forms a thin layer while passing through space between the toner doctor blade 7 and the developing roller 5 and is sufficiently charged. The thin-layered toner 8 is transferred to a developing region of the photoreceptor 1, in which an electrostatic latent image of the photoreceptor 1 is formed, by the developing roller 5.

The developing roller 5 is spaced apart from the photoreceptor 1 by a predetermined distance and faces the photoreceptor 1. The developing roller 5 rotates in a counter clockwise direction, and the photoreceptor 1 rotates in a clockwise direction.

The toner 8 transferred to the developing region of the photoreceptor 1 forms a toner image by developing the electrostatic latent image formed on the photoreceptor 1 using an electrical force generated by a potential difference between a voltage applied from a power source 12 to the developing roller 5 and electric potential of the electrostatic latent image of the photoreceptor 1.

The toner image formed on the photoreceptor 1 reaches a transferring unit 9 according to the rotation of the photoreceptor 1. A transferring bias voltage having a polarity opposite to that of the toner image is applied to the transferring unit 9 so that the toner image developed on the photoreceptor 1 is transferred to a printing medium 13. The toner image is transferred to the printing medium 13 by electrostatic force between the photoreceptor 1 and the transferring unit 9.

The toner image transferred to the printing medium 13 is fixed onto the printing medium 13 by a fixing device (not shown) at high temperature and high pressure. Meanwhile, toner 8′ remaining on the photoreceptor 1 is cleaned by a cleaning blade 10.

In general, toner includes parent toner particles, external additives, and other additives. The parent toner particles include a binder resin, a colorant, a charge control agent, and a releasing agent, and the external additives are applied to the surface of the parent toner particles.

A color image forming apparatus generally uses four colored toners (i.e., yellow (Y) toner, magenta (M) toner, cyan (C) toner, and black (K) toner) to print a color image. Thus, at least four colorants should be used in the color image forming apparatus in order to print each of the toner colors.

Generally, the parent toner particles are prepared by mixing/pulverization, suspension polymerization, or emulsion polymerization.

Particulate external additives such as silica, a metal oxide, and/or an organic material are mixed with the parent toner particles or attached to the surface of the parent toner particles to manufacture the toner.

Toner particles form a toner image by developing the electrostatic latent image of the photoreceptor 1 by frictional charge and have positive or negative charge according to the polarity of the developed latent image. In this regard, since the charging performance of the toner is mainly influenced by the external additives attached to the surface of the parent toner particles even though it is influenced by the composition of the parent toner particles, charging performance may be controlled by formulation or addition methods of the external additives.

Meanwhile, even though the external additives are uniformly attached to the surface of the parent toner particles, the toner particles may agglomerate or be attached to the toner doctor blade or a sleeve (developing roller) due to pressure applied to the toner while printing is conducted. In this case, images may not be clearly and uniformly formed after printing for a long period of time. In order to overcome such problems, external additives should be appropriately selected, and the amount and particle diameter of the external additives should be adjusted.

Various methods have been suggested in order to overcome the aforementioned problems.

Japanese Patent Publication No. 1991-100661 discloses a combination of two types of inorganic fine particles having different average particle diameters, i.e., a combination of particles having an average particle diameter of about 5 to about 20 nm and particles having an average particle diameter of about 20 to about 40 nm to improve developability, transferability, and cleaning ability. However, even though the combination has excellent developability, transferability, and cleaning ability in the initial stage, external additives are buried in or detached from the surface of the toner particles, and thus developability and transferability are significantly reduced with time.

Meanwhile, Japanese Patent Publication No. 1995-028276 discloses that large-diameter inorganic fine particles are effective for preventing external additives from being buried in toner particles. However, external additives are detached from the surface of the toner particles due to mixing stress when the size of the external additives increases since the inorganic fine particles have a large specific gravity. In addition, since the inorganic fine particles are not completely spherical in shape, standing state of external additives attached to the surface of toner particles is not uniformly controlled.

Korean Patent Publication No. 2006-0083898 discloses a method of preparing non-magnetic, mono-component toner including a first coating layer and a second coating layer formed on the surface of a toner particle, wherein the first coating layer contains coated organic powders where two types of organic powders are coated with each other, and the second coating layer contains coated inorganic powders where silica and titanium dioxide are coated with each other.

Japanese Patent Publication No. 1998-288855 discloses a method of preparing toner using a parent toner particle including a colorant and a binder resin and inorganic fine powder having a porosity of 10.0˜50.0% as an external additive.

Korean Patent Publication No. 2002-0061683 discloses a method of preparing toner having long-term reliability by securing uniform charging state among toner particles and increasing charge stability by controlling distribution of a charge control agent on the surface of toner particles.

With recent rapid development in the area of digital devices, high image quality, high imaging speed, and color imaging are increasingly required. Thus, there is a need to develop toner having accurate and efficient transferring properties and long-term charge stability.

### DISCLOSURE OF THE INVENTION

An embodiment of the present invention provides an electrophotographic toner having excellent image density and excellent transferring efficiency after printing for a long period of time, due to high charge stability and having additional effects of preventing contamination of a developing device since external additives are not detached from the surface of parent toner particles.

Another embodiment of the present invention also provides an electrophotographic image forming apparatus using the toner.

According to an aspect of the present invention, there is provided an electrophotographic toner including: a parent toner particle including a binder resin, a colorant, a releasing agent, and a charge control agent; and barium titanate coated on the surface of the parent toner particle as an external additives, having an average primary particle diameter of from about 50 to about 150 nm, for example from about 80 to about 130 nm, an average shape factor (SF1) of from about 100 to 120, a shape factor of from about 0.96 to about 1, and an aspect ratio of from about 0.89 to about 1.

The amount of the barium titanate external additives may be from about 0.3 to about 5 parts by weight, for example from about 1 to about 3 parts by weight, based on 100 parts by weight of the parent toner particle.

The parent toner particle may have a shape factor of from about 0.975 to about 1 and a volume average particle diameter of from about 5 to about 7 μm.

The electrophotographic toner may further include silica having an average primary particle diameter of from about 5 to about 50 nm, for example from about 5 to 30 nm, and surface-treated with hexamethyl disilazane (HMDS) (supplementary external additive A); and silica having an average primary particle diameter of from about 30 to about 80 nm and surface-treated with polydimethyl siloxane (PDMS) (supplementary external additive B), as external additives.

The electrophotographic toner may further include an inorganic compound having an average primary particle diameter of from about 10 to about 100 nm, for example from about 50 to about 90 nm (supplementary external additive C); as an external additive.

The electrophotographic toner may include about 1 to about 16 parts by weight of external additives based on 100 parts by weight of the parent toner particle. In particular, the amount of the supplementary external additive A may be from about 0.5 to about 5 parts by weight; the amount of the supplementary external additive B may be from about 0.1 to about 3 parts by weight; and the amount of the supplementary external additive C may be from about 0.1 to about 3 parts by weight based on 100 parts by weight of the parent toner particle.

According to another aspect of the present invention, there is provided an electrophotographic image forming apparatus employing the electrophotographic toner.

### BRIEF DESCRIPTION OF THE DRAWINGS

The above and/or other aspects will become apparent and more readily appreciated from the following description of the embodiments, taken in conjunction with the accompanying drawings of which:

FIG. 1 schematically illustrates a non-contact developing type electrophotographic image forming apparatus;

FIG. 2A schematically illustrates the distribution of spherical external additives attached to the surface of a parent toner particle; and

FIG. 2B schematically illustrates the distribution of a mixture of spherical and non-spherical external additives attached to the surface of a parent toner particle.

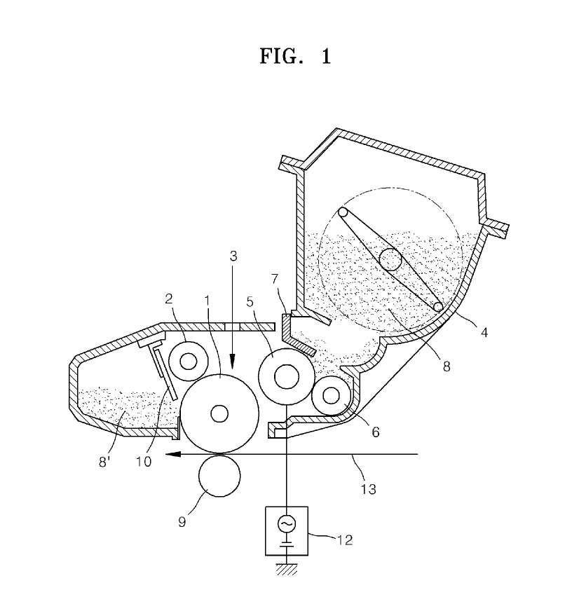

### BEST MODE FOR CARRYING OUT THE INVENTION

Hereinafter, the present invention will be described in more detail with reference to exemplary embodiments of the invention.

An electrophotographic toner according to an embodiment of the present invention includes parent toner particles and external additives.

The parent toner particles may include a binder resin, a colorant, a releasing agent and a charge control agent, etc.

The binder resin binds other elements contained in the parent toner particles, such as the colorant, the charge control agent, and/or the releasing agent, and/or external additives or fixes the toner to a printing medium. The binder resin may be any resin known in the art, for example, polystyrene, poly-p-chlorostyrene, poly-α-methylstyrene, styrene-based copolymers such as styrene-chlorostyrene copolymer, styrene-propylene copolymer, styrene-vinyltoluene copolymer, styrene-vinyl naphthalene copolymer, styrene-methyl acrylate copolymer, styrene-ethyl acrylate copolymer, styrene-propyl acrylate copolymer, styrene-butyl acrylate copolymer, styrene-octyl acrylate copolymer, styrene-methyl methacrylate copolymer, styrene-ethyl methacrylate copolymer, styrene-propyl methacrylate copolymer, styrene-butyl methacrylate copolymer, styrene-α-methyl chloromethacrylate copolymer, styrene-acrylonitrile copolymer, styrene-vinyl methyl ether copolymer, styrene-vinyl ethyl ether copolymer, styrene-vinyl ethyl ketone copolymer, styrene-butadiene copolymer, styrene-acrylonitrile-indene copolymer, styrene-maleic acid copolymer, and styrene-maleic ester copolymer; polymethyl methacrylate, polyethyl methacrylate, polybutyl methacrylate, and copolymers thereof; polyvinyl chloride, polyvinyl acetate, polyethylene, polypropylene, polyester, polyurethane, polyamide, epoxy resin, polyvinyl butyral resin, rosin, modified rosin, terpene resin, phenol resin, aliphatic or alicyclic hydrocarbon resin, aromatic petroleum resin, chlorinated paraffin, paraffin wax, or the like. These compounds may be used alone or in combination. Among these compounds, polyester-based resins are suitable for a color toner due to their excellent fixing properties and transparency.

The colorant is used for a color toner. Toners containing black (K), yellow (Y), magenta (M), and cyan (C) colorants are used as an electrophotographic toner. The toner may be used in an electrophotographic image forming apparatus. An image forming apparatus using toner containing only a black colorant is referred to as a black and white image forming apparatus, and an image forming apparatus including four colored toners is referred to as a color image forming apparatus.

The black colorant may be an iron oxide, carbon black, or a titanium oxide, but is not limited thereto.

The yellow colorant may be a condensed nitrogen compound, an isoindolinone compound, an anthraquine compound, an azo metal complex, or an allyl imide compound. In detail, the yellow colorant may be C.I. pigment yellow 12, 13, 14, 17, 62, 74, 83, 93, 94, 95, 109, 110, 111, 128, 129, 147, 168, or the like.

The magenta colorant may be a condensed nitrogen compound, an anthraquine compound, a quinacridone compound, a base dye lake compound, a naphthol compound, a benzo imidazole compound, a thioindigo compound, or a perylene compound. In detail, the magenta colorant may be C.I. pigment red 2, 3, 5, 6, 7, 23, 48:2, 48:3, 48:4, 57:1, 81:1, 144, 146, 166, 169, 177, 184, 185, 202, 206, 220, 221, 254, or the like.

The cyan pigment may be a copper phthalocyanine compound or derivatives thereof, an anthraquine compound, or a base dye lake compound. In detail, the cyan pigment may be C.I. pigment blue 1, 7, 15, 15:1, 15:2, 15:3, 15:4, 60, 62, 66, or the like.

The colorants may be used alone or in a combination of two or more colorants, and are selected in consideration of hue, chroma, brightness, weather resistance, dispersibility in toner, etc.

The colorant may be used in an amount sufficient to color the toner and form a visible image by development, for example about 2 to about 20 parts by weight based on 100 parts by weight of the binder resin. If the amount of the colorant is less than 2 parts by weight based on 100 parts by weight of the binder resin, coloring effect is not sufficient. On the other hand, if the amount of the colorant is greater than 20 parts by weight based on 100 parts by weight of the binder resin, electrical resistance of the toner is decreased so that the amount of frictional charge is not sufficient, thereby causing contamination.

The charge control agent may be negative charging type or positive charging type. Examples of the negative charging type charge control agent include an organic metal complex or a chelate compound such as an azo complex containing chromium or a monoazo metal complex; a salicylic acid compound containing metal such as chromium, iron or zinc; and an organic metal complex of an aromatic hydroxycarboxylic acid and an aromatic dicarboxylic acid, and any known charge control agent may be used without limitation. In addition, examples of the positive charging type charge control agent include a modified product such as Nigrosine and a fatty acid metal salt thereof and an onium salt including a quaternary ammonium salt such as tributylbenzylammonium 1-hydroxy-4-naphthosulfonate and tetrabutylammonium tetrafluoro borate. These charge control agents may be used alone or in combination of at least two. Such a charge control agent charges the toner stably and rapidly by electrostatic force, and thus stably supporting the toner on a developing roller.

The amount of the charge control agent contained in toner may be in a range of about 0.1 parts by weight to about 10 parts by weight based on 100 parts by weight of the toner.

The parent toner particles according to the present embodiment may include a releasing agent for improving fixing properties of a toner image. Examples of the releasing agent include polyalkylene wax such as low molecular weight polypropylene and low molecular weight polyethylene, ester wax, carnauba wax, paraffin wax, montan wax, rice wax, and candelilla wax.

The parent toner particles may further include a long chain fatty acid, fatty acid amide, or a metal salt thereof, in order to protect a photoreceptor, prevent deterioration of developing properties, and obtain a high quality image.

An average aspect ratio of the parent toner particles may be in a range of about 0.975 to about 1.0, for example about 0.980 to about 1.0. When the average aspect ratio is 1.0, the parent toner particles have a completely spherical shape. As the average aspect ratio is decreased, sphericity is decreased and the surface area is increased so that electrostatic adhesion force is increased, thereby decreasing transferring efficiency.

Furthermore, as the average aspect ratio of the parent toner particles is decreased, the amount of external additives buried in the parent toner particles is increased and the external additives are not uniformly attached to the surface of the parent toner particles. Thus, when the average aspect ratio is less than 0.975, roles of the external additives (e.g., charging, functioning as a spacer, and providing mobility) may be weakened.

The aspect ratio may be calculated using Equation 1 below by measuring scanning electron microscope (SEM) images (×1,500) of 100 random parent toner particle samples and analyzing the measured data using an image J software.

1/aspect ratio=length of longest axis of particle/the longest length of axis perpendicular to longest axis of particle Equation 1

The aspect ratio may be in a range of 0 to 1. The closer the aspect ratio is to 1, the higher the sphericity.

In addition, the parent toner particles may have a volume average particle diameter in a range of about 5 to about 7 μm, for example about 5.5 to about 6.5 μm. When the volume average particle diameter is less than 5 μm, the total surface area of the parent toner particles is increased and the electrostatic adhesion force is increased, and thus transferring efficiency is rapidly decreased. On the other hand, when the volume average particle diameter is greater than 7 μm, toner is scattered during the developing and transferring processes, and reproductibility of electrostatic latent images may be decreased, and thus high quality images may not be obtained. The parent toner particles may have the volume average particle diameter described above for improving reproductibility of color in full color images. However, the volume average particle diameter of the parent toner particles needs to be decreased as resolution of printed images is increased, and the particle diameter may be regulated according to methods of preparing toner. Thus, the scope of the present invention is not limited by the range of particle diameter described above.

The parent toner particles may be prepared using conventional methods without limitation. For example, the parent toner particles may be prepared using: melt-mixing pulverization by which a binder resin, a colorant, a releasing agent, and a charge control agent are melt-mixed, the mixture is pulverized, and the pulverized particles are classified; a method of changing the shape of toner particles by applying mechanical impact or heat energy to particles obtained by melt-mixing pulverization; emulsion polymerization-aggregation by which polymerizable monomer(s) is(are) emulsion-polymerized to form a dispersion, the dispersion, a colorant, a releasing agent, and a charge control agent are mixed, and the mixture is aggregated and coalesced; suspension polymerization by which a mixture of polymerizable monomer(s) for a binder resin, a colorant, a releasing agent, and a charge control agent is suspended in an aqueous solvent and the suspension is polymerized; or melting suspension by which a mixture of a binder resin, a colorant, a releasing agent, and charge control agent is suspended in an aqueous solvent.

A parent toner particle having a core-shell structure may be prepared by attaching particles of monomer(s) or a binder resin to a core formed of the parent toner particle prepared according to one of the methods described above, aggregating the resultant, and coalescing the aggregated resultant by heating.

External additives are attached to the surface of the parent toner particle in order to provide the toner with mobility, charge stability, cleaning ability, and other properties required for the toner. Barium titanate, which is used as the external additive according to the current embodiment, may control a charge amount by reducing dependence of the charge amount of toner on temperature and/or humidity, does not change mobility, and may uniformly control mixing efficiency in a developing device. Thus, the charge amount of toner may be uniformly maintained, and contamination in the developing device may be reduced. Furthermore, transferring properties may be maintained at a level the same as or similar to that in the initial stage, high image quality may be stably maintained for a long period of time, and charge stability may be excellent.

In addition, the barium titanate as an external additive may have an average shape factor (SF1) in a range of about 100 to about 120, a shape factor in a range of about 0.96 to about 1, and an aspect ratio in a range of about 0.89 to about 1. If the average shape factor (SF1), the shape factor, and/or the aspect ratio are not within the ranges described above, the original shape of the parent toner particle may be changed when the barium titanate external additive is attached to the parent toner particle, and thus the developing device may be contaminated, or the charging roller may be contaminated or damaged.

The aspect ratio may be calculated using Equation 1 above by measuring SEM images (×100,000) of 100 random external additive particles and analyzing the measured data using Image J software.

The shape factor may be calculated using Equation 2 below by measuring SEM images (×100,000) of 100 random external additive particles and analyzing the measured data using Image J. Software.

Shape factor=4π(area/(perimeter)²). Equation 2

In Equation 2, the area is a projected area of the external additive particles, and the perimeter is a circumference of the projected image of the external additive particles. The shape factor may be in a range of 0 to 1. The closer the value of the shape factor is to 1, the higher the sphericity.

The average shape factor (SF1) may be calculated using Equation 3 below by measuring SEM images (×100,000) of 100 random external additive particles and analyzing the measured data using Image J. Software.

Average shape factor (SF1)=[(maximum diameter)²/projected area]×(π/4)×100. Equation 3

If the SF1 is in the range of 100 to 120, the particle is close to spherical in shape. If the SF1 is in the range of 140 to 150, the particle has a non-spherical shape.

Meanwhile, the parent toner particle and the external additives may be mixed using a Henschel mixer, a V mixer, or a Cyclo mixer to prepare toner to which external additives are attached.

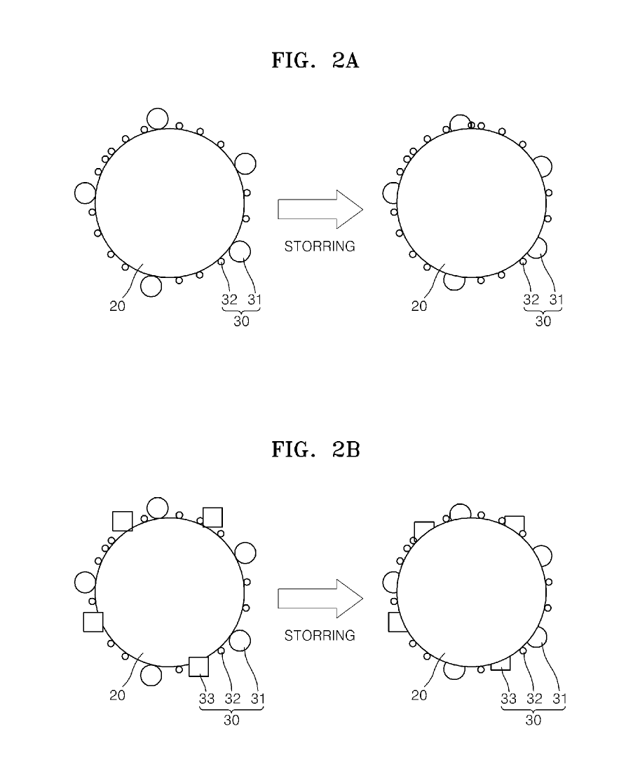

FIG. 2A schematically illustrates the distribution of spherical external additives 30 attached to the surface of a parent toner particle 20. FIG. 2B schematically illustrates the distribution of a mixture of spherical and non-spherical external additives 30 attached to the surface of a parent toner particle 20.

Referring to FIG. 2A, the spherical external additives 30 include large spherical particulate external additives 31 and small spherical particulate external additives 32 attached to the surface of the parent toner particle 20. When the parent toner particles 20 to which the spherical external additives 30 are attached are stirred, the overall shape of the parent toner particles 20 are not significantly changed even though the large spherical particulate external additives 31 are partially buried in the surface of the parent toner particles 20, and the shape of the spherical external additives 30 are not changed from their original shape, and thus each of the large and small spherical particulate external additives 31 and 32 are uniformly distributed on the surface of the parent toner particle 20.

On the other hand, referring to FIG. 2B, the mixture of spherical and non-spherical external additives 30 includes large spherical particulate external additives 31, small spherical particulate external additives 32, and large non-spherical (hexahedron) particulate external additives 33. When the parent toner particles 20 to which the mixture of spherical and non-spherical external additives 30 are attached are stirred, the large spherical large particulate external additives 31 are partially buried in the surface of the parent toner particles 20 so that the original shape of the parent toner particles 20 is maintained, but the large non-spherical particulate external additives 33 are considerably buried in the surface of the parent toner particles 20 so that the original shape of parent toner particles 20 is not maintained and the overall shape of the parent toner particles 20 is changed. Furthermore, each of the large spherical particulate external additives 31, small spherical particulate external additives 32, and large non-spherical (hexahedron) particulate external additives 33 are not uniformly distributed on the surface of the parent toner particle 20.

The barium titanate external additive may have an average primary particle diameter in a range of about 50 to about 150 nm. If the average primary particle diameter of the barium titanate external additive is less than 50 nm, the barium titanate external additive is buried in the surface of parent toner particles so that charging properties or mobility may be decreased. On the other hand, if the average primary particle diameter of the barium titanate external additive is greater than 150 nm, the barium titanate external additives on the surface of the parent toner particle collide with each other so that contamination may occur.

The amount of the barium titanate external additive may be in a range of about 0.3 to about 5 parts by weight, for example about 1 to about 3 parts by weight based on 100 parts by weight of the parent toner particle. If the amount of the external additive is less than 0.3 parts by weight based on 100 parts by weight of the parent toner particle, charge stability is not sufficient. On the other hand, if the amount of the external additive is greater than 5 parts by weight based on 100 parts by weight of the parent toner particle, the parent toner particle is excessively coated so that secondary problems, which will be described later, may be caused due to excessive contact with inorganic compounds.

Two or more types of external additives having different average primary particle diameters may be used together in order to prevent detachment of external additives from the parent toner particle or burying of external additives into the parent toner particle that may cause image quality deterioration. In addition, the external additives may be surface-treated with a surface treating agent such as hexamethyl disilazane (HMDS) and/or polydimethyl siloxane (PDMS) in order to improve mobility, preservability, frictional chargability, mixability, developability, and transferring stability of toner.

For example, the external additives may include silica having an average primary particle diameter in a range of about 5 to about 50 nm, and surface-treated with hexamethyl disilazane (HMDS), constituting supplementary external additive A; and silica having an average primary particle diameter in a range of about 30 to about 80 nm, and surface-treated with polydimethyl siloxane (PDMS), constituting supplementary external additive B. However, the present invention is not limited thereto. The external additives may include conventional large particulate silicia and small particulate silica instead of the supplementary external additives A and B. The external additives may further include an inorganic compound having an average primary particle diameter in a range of about 10 to about 100 nm, constituting supplementary external additive C. In this regard, external additives having a relatively large diameter, as a spacer, prevent toner from being deteriorated and improve charge stability, and external additives having a relatively small diameter provide mobility to the toner.

The average primary particle diameter of the external additives is measured using a laser diffraction/scattering type, particle distribution measuring device (Malvern 2000).

If the average primary particle diameter of the supplementary external additive A used herein is less than 5 nm, it is difficult to manufacture the supplementary external additive A, its manufacturing costs are increased, and the supplementary external additive A is buried into the parent toner particle, thereby having adverse effects on charging or mobility. On the other hand, if the average primary particle diameter of the supplementary external additive A is greater than 50 nm, non-electrostatic adhesion force is decreased and external additives are easily detached from the surface of the parent toner particle so that secondary problems such as charging interruption and image defects may occur. The supplementary external additive A may be monodispersed spherical silica having an average primary particle diameter in a range of about 5 nm to about 30 nm.

Examples of the supplementary external additive A, which is silica surface-treated with hexamethyl disilazane (HMDS), include RX300, RX812, R812S, RX200, RX8200, NX90, NAX50, RX50 (manufactured by Aerosil, Japan), TG810G (manufactured by Cabot Corporation), and the like.

The amount of the supplementary external additive A may be in a range of about 0.5 to about 5 parts by weight, for example about 1 to about 3 parts by weight based on 100 parts by weight of the parent toner particle. If the amount of the supplementary external additive A is less than 0.5 parts by weight based on 100 parts by weight of the parent toner particle, non-electrostatic adhesion force is not sufficient, and developing and transferring properties are not sufficiently improved. On the other hand, if the amount of the supplementary external additive A is greater than 5 parts by weight based on 100 parts by weight of the parent toner particle, the parent toner particle is excessively coated so that secondary problems such as charging interruption and image defects may occur.

The supplementary external additive A is uniformly distributed on the surface of the parent toner particle. Since the supplementary external additive A controls mobility and charging properties of toner and sufficiently covers the surface of the parent toner particle, but does not efficiently function as a spacer, the supplementary external additive A may be used with large particulate silica.

The supplementary external additive B may be attached to the surface of the parent toner particle in order to improve frictional chargability, mixability, developability, image density, and transferring stability of toner.

If the supplementary external additive B is used with the supplementary external additive C and barium titanate, high frictional electric charge may be provided to the toner. Examples of the supplementary external additive B include RY50, NY50, RY200, RY200S, and R202 (manufactured by Aerosil, Japan).

The supplementary external additive B may have an average primary particle diameter in a range of about 40 to about 60 nm. If the average primary particle diameter of the supplementary external additive B used herein is less than 30 nm, its manufacturing costs are increased, and the supplementary external additive B is buried into the parent toner particle, thereby having adverse effects on charging or mobility. On the other hand, if the average primary particle diameter of the supplementary external additive B is greater than 80 nm, charging properties are decreased.

The amount of the supplementary external additive B may be in a range of about 0.1 to about 3 parts by weight, for example about 0.3 to about 2 parts by weight based on 100 parts by weight of the parent toner particle. If the amount of the supplementary external additive B is less than 0.1 parts by weight based on 100 parts by weight of the parent toner particle, non-electrostatic adhesion force is not sufficient. On the other hand, if the amount of the supplementary external additive B is greater than 3 parts by weight based on 100 parts by weight of the parent toner particle, the parent toner particle is excessively coated so that secondary problems such as charging interruption and image defects may occur.

The inorganic compound used as the supplementary external additive C may be silica, a titanium compound, alumina, calcium carbonate, magnesium carbonate, calcium phosphate, a cesium oxide, a barium oxide, or the like. The supplementary external additive C may be surface-treated using conventional methods, if required.

The supplementary external additive C is used to control charging. A titanium compound may be used as the supplementary external additive C in order to inhibit dependence of the charge amount of toner on temperature and/or humidity. The titanium compound used as the supplementary external additive C may be surface-treated with strontium.

The supplementary external additive C may have an average primary particle diameter in a range of about 10 to about 100 nm, for example about 40 to about 60 nm. If the average primary particle diameter of the supplementary external additive C used herein is less than 10 nm, its manufacturing costs are high, and contamination may occur since the supplementary external additive C is not uniformly mixed with other external additives. If the average primary particle diameter of the supplementary external additive C is greater than 100 nm, contamination may occur after the supplementary external additive C is externally added to the parent toner particle due to the size or shape of the particle, or the external addition may have adverse effects on charging.

The amount of the supplementary external additive C may be in a range of about 0.1 to about 3 parts by weight, for example about 0.3 to about 1 part by weight based on 100 parts by weight of the parent toner particle. If the amount of the supplementary external additive C is less than 0.3 parts by weight based on 100 parts by weight of the parent toner particle, charge control may not be appropriately conducted. On the other hand, if the amount of the supplementary external additive C is greater than 5 parts by weight based on 100 parts by weight of the parent toner particle, the parent toner particle is excessively coated so that secondary problems may be caused due to excessive contact with inorganic compounds as described above.

Various other additives may be added to the toner, if required, in addition to the external additives described above. Examples of such additives include a fluidizing agent; a cleaning coagent such as polystyrene particulates, polymethylmethacrylate particulates, and polyvinylidenefluoride particulates; and a transferring coagent.

Hereinafter, methods of preparing an electrophotographic toner according to the present invention will be described in detail.

First, a method comprising melt-mixing pulverization will be described.

A colorant may be pre-treated in order to be uniformly dispersed in a binder resin. For this, the colorant may be subjected to flushing in advance, or a master batch where the colarant is dispersed in the binder resin at a high concentration may be used. The binder resin may be mixed with the colorant using a mixing device such as a two-roll mill, a three-roll mill, a pressurizing kneader, or a two-screw extruder. The mixture of the binder resin and the colorant may be melt-mixed at a temperature ranging from about 80 to about 180 for 10 minutes to 2 hours. Then, the mixture is pulverized using a pulverizer such as a jet mill, an attritor mill, or a rotary mill, and the pulverized particles are classified to have parent toner particles having a volume average particle diameter in a range of about 7 to about 9 μm. Mobility or charge stability of toner may be improved by adding external additives to the parent toner particles.

Next, a method comprising emulsion polymerization/aggregation will be described.

An emulsion including a binder resin, a colorant, and a releasing agent is prepared and polymerized to form a toner composition having a particle diameter of about 1 μm or less, and the toner composition is aggregated to produce first aggregated toner particles having a particle diameter ranging from about 1 μm to about 3 μm. Then, a latex having a molecular weight different from that of the first aggregated toner particles is added to the first aggregated toner particles, and the mixture is aggregated to prepare parent toner particles having a particle diameter ranging from about 5 μm to about 10 μm.

In addition, external additives are attached to the parent toner particles by mixing the parent toner particles and the external additives in a predetermined ratio, filling the mixture in a stirring device such as a Henschel mixer, and stirring the mixture. Alternatively, at least a portion of the external additive particles may be buried into the parent toner particles to fix the external additive particles to the parent toner particles by filling both of the external additive particles and the parent toner particles in a particle surface modifying device such as NARA-hybridizer and stirring the mixture.

The electrophotographic toner may also be applied to a contact type, non-magnetic, mono-component electrophotographic toner as well as a non-contact type, non-magnetic, mono-component electrophotographic toner. In contact type development, a developing roller contacts the surface of a photoreceptor so that an electrostatic latent image is developed using toner. In non-contact type development, a developing roller is spaced apart from the surface of a photoreceptor so that a latent image is developed using electrical force generated by a potential difference between a voltage applied to the developing roller and electric potential of the electrostatic latent image of the photoreceptor.

The present invention will be described in more detail with reference to the examples below. However, these examples are for illustrative purposes only and are intended to limit the scope of the invention.

### EXAMPLES

### Examples 1-1 to 1-15 and Comparative Examples 1-1 to 1-8

### Preparation of Cyan Parent Toner Particles

460 g of polyester resin (molecular weight: 2.5×10⁴), 25 g of phthalocyanine pigment blue 15:3, 5 g of a quaternary ammonium salt, and 10 g of low molecular weight polypropylene (weight average molecular weight: 3.5×10³˜4.5×10³) were mixed using a Henschel mixer. The mixture was melt-mixed at a temperature of 165 in a twin screw extruder and pulverized using a jet mill pulverizer, and the pulverized particles were classified in an air classifier to obtain parent toner particles having a volume average particle diameter of 7.0 μm.

(Addition of External Additives)

External additives shown in Table 1 below were added to the parent toner particles prepared using the melt-mixing pulverization method described above in a mixing ratio as described in Table 2 below to prepare toner according to each of Examples 1-1 to 1-15 and Comparative Examples 1-1 to 1-8. The addition of the external additives was conducted by adding each of the external additives of Table 1 to the parent toner particles (based on 100 parts by weight of the parent toner particles) and mixing them using a Henschel mixer for 3 minutes.

TABLE 1

| External | | | |
|---|---|---|---|
| additives | Properties | | indicated as |
| Barium titanate | SF1: 115, shape factor: 0.98, aspect ratio: 0.95, average | | 100 nm Ba-1 |
| | primary particle diameter: 100 nm | | |
| | SF1: 130, shape factor: 0.98, aspect ratio: 0.95, average | | 100 nm Ba-2 |
| | primary particle diameter: 100 nm | | |
| | SF1: 115, shape factor: 0.90, aspect ratio: 0.95, average | | 100 nm Ba-3 |
| | primary particle diameter: 100 nm | | |
| | SF1: 115, shape factor: 0.98, aspect ratio: 0.80, average | | 100 nm Ba-4 |
| | primary particle diameter: 100 nm | | |
| | SF1: 115, shape factor: 0.98, aspect ratio: 0.80, average | | 40 nm Ba-5 |
| | primary particle diameter: 40 nm | | |
| | SF1: 115, shape factor: 0.98, aspect ratio: 0.80, average | | 160 nm Ba-6 |
| | primary particle diameter: 160 nm | | |
| Supplementary | Silica surface-treated with | average primary | 30 nm H—SiO₂ |
| external | HMDS | particle diameter: 30 nm | |
| additive A | | average primary | 3 nm H—SiO₂ |
| | | particle diameter: 3 nm | |
| | | average primary | 60 nm H—SiO₂ |
| | | particle diameter: 60 nm | |
| | Surface-untreated Silica | average primary | 30 nm SiO₂ |
| | | particle diameter: 30 nm | |
| Supplementary | Silica surface-treated with | average primary | 55 nm P—SiO₂ |
| external | PDMS | particle diameter: 55 nm | |
| additive B | | average primary | 20 nm P—SiO₂ |
| | | particle diameter: 20 nm | |
| | | average primary | 90 nm P—SiO₂ |
| | | particle diameter: 90 nm | |
| | Surface-untreated Silica | average primary | 55 nm SiO₂ |
| | | particle diameter: 55 nm | |

| | | |
|---|---|---|
| Supplementary | Titanium dioxide surface-treated with strontium, | 80 nm St-TiO₂ |
| external | average primary particle diameter: 80 nm | |
| additive C | Titanium dioxide surface-treated with strontium, | 5 nm St-TiO₂ |
| | average primary particle diameter: 5 nm | |
| | Titanium dioxide surface-treated with strontium, | 110 nm St-TiO₂ |
| | average primary particle diameter: 110 nm | |
| | Surface-untreated titanium dioxide, average primary | 80 nm TiO₂ |
| | particle diameter: 80 nm | |

TABLE 2

| | | Supplementary | Supplementary | Supplementary |
|---|---|---|---|---|
| Examples and | Barium titanate | external additive A | external additive B | external additive C |
| Comparative | (amount, parts by | (amount, parts by | (amount, parts by | (amount, parts by |
| Examples | weight) | weight) | weight) | weight) |
| Example 1-1 | 100 nm Ba-1 | 30 nm SiO₂ | 55 nm SiO₂ | — |
| | (2.5) | (2.5) | (1.5) | |
| Example 1-2 | 100 nm Ba-1 | 30 nm SiO₂ | 55 nm SiO₂ | 80 nm TiO₂ |
| | (2.5) | (2.5) | (1.5) | (1.5) |
| Example 1-3 | 100 nm Ba-1 | 30 nm H—SiO₂ | 55 nm P—SiO₂ | — |
| | (2.5) | (2.5) | (1.5) | |
| Example 1-4 | 100 nm Ba-1 | 30 nm H—SiO₂ | 55 nm P—SiO₂ | 80 nm St-TiO₂ |
| | (2.5) | (2.5) | (1.5) | (1.5) |
| Example 1-5 | 100 nm Ba-1 | 30 nm H—SiO₂ | 55 nm P—SiO₂ | 80 nm St-TiO₂ |
| | (0.2) | (2.5) | (1.5) | (1.5) |
| Example 1-6 | 100 nm Ba-1 | 30 nm H—SiO₂ | 55 nm P—SiO₂ | 80 nm St-TiO₂ |
| | (7.0) | (2.5) | (1.5) | (1.5) |
| Example 1-7 | 100 nm Ba-1 | 3 nm H—SiO₂ | 55 nm P—SiO₂ | 80 nm St-TiO₂ |
| | (2.5) | (2.5) | (1.5) | (1.5) |
| Example 1-8 | 100 nm Ba-1 | 60 nm H—SiO₂ | 55 nm P—SiO₂ | 80 nm St-TiO₂ |
| | (2.5) | (2.5) | (1.5) | (1.5) |
| Example 1-9 | 100 nm Ba-1 | 30 nm H—SiO₂ | 20 nm P—SiO₂ | 80 nm St-TiO₂ |
| | (2.5) | (2.5) | (1.5) | (1.5) |
| Example 1-10 | 100 nm Ba-1 | 30 nm H—SiO₂ | 90 nm P—SiO₂ | 80 nm St-TiO₂ |
| | (2.5) | (2.5) | (1.5) | (1.5) |
| Example 1-11 | 100 nm Ba-1 | 30 nm H—SiO₂ | 55 nm P—SiO₂ | 5 nm St-TiO₂ |
| | (2.5) | (2.5) | (1.5) | (1.5) |
| Example 1-12 | 100 nm Ba-1 | 30 nm H—SiO₂ | 55 nm P—SiO₂ | 110 nm St-TiO₂ |
| | (2.5) | (2.5) | (1.5) | (1.5) |
| Example 1-13 | 100 nm Ba-1 | 30 nm H—SiO₂ | 55 nm P—SiO₂ | 80 nm St-TiO₂ |
| | (2.5) | (6.5) | (1.5) | (1.5) |
| Example 1-14 | 100 nm Ba-1 | 30 nm H—SiO₂ | 55 nm P—SiO₂ | 80 nm St-TiO₂ |
| | (2.5) | (2.5) | (4.5) | (1.5) |
| Example 1-15 | 100 nm Ba-1 | 30 nm H—SiO₂ | 55 nm P—SiO₂ | 80 nm St-TiO₂ |
| | (2.5) | (2.5) | (1.5) | (4.5) |
| Comparative | — | 30 nm SiO₂ | 55 nm SiO₂ | 80 nm TiO₂ |
| Example 1-1 | | (2.5) | (1.5) | (1.5) |
| Comparative | — | 30 nm H—SiO₂ | 55 nm P—SiO₂ | 80 nm St-TiO₂ |
| Example 1-2 | | (2.5) | (1.5) | (1.5) |
| Comparative | 100 nm Ba-2 | 30 nm H—SiO₂ | 55 nm P—SiO₂ | 80 nm St-TiO₂ |
| Example 1-3 | (2.5) | (2.5) | (1.5) | (1.5) |
| Comparative | 100 nm Ba-3 | 30 nm H—SiO₂ | 55 nm P—SiO₂ | 80 nm St-TiO₂ |
| Example 1-4 | (2.5) | (2.5) | (1.5) | (1.5) |
| Comparative | 100 nm Ba-4 | 30 nm H—SiO₂ | 55 nm P—SiO₂ | 80 nm St-TiO₂ |
| Example 1-5 | (2.5) | (2.5) | (1.5) | (1.5) |
| Comparative | 40 nm Ba-5 | 30 nm H—SiO₂ | 55 nm P—SiO₂ | 80 nm St-TiO₂ |
| Example 1-6 | (2.5) | (2.5) | (1.5) | (1.5) |
| Comparative | 160 nm Ba-6 | 30 nm H—SiO₂ | 55 nm P—SiO₂ | 80 nm St-TiO₂ |
| Example 1-7 | (2.5) | (2.5) | (1.5) | (1.5) |

### Examples 2-1 to 2-15 and Comparative Examples 2-1 to 2-8

### Preparation of Cyan Parent Toner Particle

Preparation of Latex Particle

0.5 g of sodium dodecyl sulfate (SDS), as an anionic surfactant, was mixed with 400 g of ultra pure water from which oxygen was removed to obtain an aqueous solution. The solution was heated to 80 in a reaction chamber. When the temperature of the solution reached 80, an initiator solution prepared by dissolving 0.2 g of potassium persulfate in 30 g of ultra pure water was added thereto. After 10 minutes, 105.5 g of a mixture including 81 g of styrene, 22 g of butyl acrylate, and 2.5 g of methacrylic acid was added thereto for about 30 minutes. After 4 hours of reaction, the heating was stopped and the mixture was naturally cooled to obtain a seed solution. 30 g of the seed solution was mixed with 351 g of ultra pure water, and the mixture was heated to 80. The resultant was mixed with 17 g of ester wax, 18 g of styrene monomer, 7 g of butyl acrylate, 1.3 g of methacrylic acid, and 0.4 g of dodecanethiol, and the mixture was melted by heating. The wax/monomer mixture was added to a solution prepared by dissolving 1 g of SDS in 220 g of ultra pure water, and the mixture was homogenized using an ultrasonic homogenizer for about 10 minutes to obtain a homogenized emulsion. The homogenized emulsion was added to the reaction chamber filled with the seed solution. After about 15 minutes, an initiator solution prepared by dissolving 5 g of potassium persulfate in 40 g of ultra pure water was added thereto. In this regard, the temperature was maintained at 82, and the reaction was performed for 2.5 hours. Then, an initiator solution prepared by dissolving 1.5 g of potassium persulfate in 60 g of ultra pure water was added thereto, and monomers for forming a shell layer, i.e., 56 g of styrene, 20 g of butyl acrylate, 4.5 g of methacrylic acid, and 3 g of dodecanethiol were added thereto for about 80 minutes. After 2 hours, the reaction was terminated and the mixture was naturally cooled to obtain latex particles.

Aggregating/Coalescing Process

318 g of the prepared dispersion including the latex particles was mixed with a solution prepared by dissolving 0.5 g of SDS emulsifier in 310 g of ultra pure water. 18.2 g (solid: 40% by weight) of a pigment (cyan) dispersion prepared by dispersing a pigment using the SDS emulsifier was added thereto to obtain a latex pigment dispersion. Then, while stirring the mixture at 250 rpm, the pH of the latex pigment dispersion was adjusted to 10 using a 10 mol % NaOH buffer solution. An aggregating agent solution prepared by dissolving 10 g of MgCl₂ in 30 g of ultra pure water was added to the latex pigment dispersion for 10 minutes. Then, the mixture was heated to 95 at a rate of 1/min. The mixture was reacted for 3 hours and was naturally cooled to obtain parent toner particles. Here, the volume average particle diameter of the parent toner particles was 6.5 μm.

(Addition of External Additives)

Each of external additives shown in Table 3 was added to the parent toner particles prepared above to prepare toner according to each of Examples 2-1 to 2-15 and Comparative Examples 2-1 to 2-8. Each of the external additives was added to the parent toner particles (based on 100 parts by weight of the parent toner particles) and was mixed using a Henschel mixer for 3 minutes

TABLE 3

| | | Supplementary | Supplementary | Supplementary |
|---|---|---|---|---|
| Examples and | Barium titanate | external additive A | external additive B | external additive C |
| Comparative | (amount, parts by | (amount, parts by | (amount, parts by | (amount, parts by |
| Examples | weight) | weight) | weight) | weight) |
| Example 2-1 | 100 nm Ba-1 | 30 nm SiO₂ | 55 nm SiO₂ | — |
| | (2.5) | (2.5) | (1.5) | |
| Example 2-2 | 100 nm Ba-1 | 30 nm SiO₂ | 55 nm SiO₂ | 80 nm TiO₂ |
| | (2.5) | (2.5) | (1.5) | (1.5) |
| Example 2-3 | 100 nm Ba-1 | 30 nm H—SiO₂ | 55 nm P—SiO₂ | — |
| | (2.5) | (2.5) | (1.5) | |
| Example 2-4 | 100 nm Ba-1 | 30 nm H—SiO₂ | 55 nm P—SiO₂ | 80 nm St-TiO₂ |
| | (2.5) | (2.5) | (1.5) | (1.5) |
| Example 2-5 | 100 nm Ba-1 | 30 nm H—SiO₂ | 55 nm P—SiO₂ | 80 nm St-TiO₂ |
| | (0.2) | (2.5) | (1.5) | (1.5) |
| Example 2-6 | 100 nm Ba-1 | 30 nm H—SiO₂ | 55 nm P—SiO₂ | 80 nm St-TiO₂ |
| | (7.0) | (2.5) | (1.5) | (1.5) |
| Example 2-7 | 100 nm Ba-1 | 3 nm H—SiO₂ | 55 nm P—SiO₂ | 80 nm St-TiO₂ |
| | (2.5) | (2.5) | (1.5) | (1.5) |
| Example 2-8 | 100 nm Ba-1 | 60 nm H—SiO₂ | 55 nm P—SiO₂ | 80 nm St-TiO₂ |
| | (2.5) | (2.5) | (1.5) | (1.5) |
| Example 2-9 | 100 nm Ba-1 | 30 nm H—SiO₂ | 20 nm P—SiO₂ | 80 nm St-TiO₂ |
| | (2.5) | (2.5) | (1.5) | (1.5) |
| Example 2-10 | 100 nm Ba-1 | 30 nm H—SiO₂ | 90 nm P—SiO₂ | 80 nm St-TiO₂ |
| | (2.5) | (2.5) | (1.5) | (1.5) |
| Example 2-11 | 100 nm Ba-1 | 30 nm H—SiO₂ | 55 nm P—SiO₂ | 5 nm St-TiO₂ |
| | (2.5) | (2.5) | (1.5) | (1.5) |
| Example 2-12 | 100 nm Ba-1 | 30 nm H—SiO₂ | 55 nm P—SiO₂ | 110 nm St-TiO₂ |
| | (2.5) | (2.5) | (1.5) | (1.5) |
| Example 2-13 | 100 nm Ba-1 | 30 nm H—SiO₂ | 55 nm P—SiO₂ | 80 nm St-TiO₂ |
| | (2.5) | (6.5) | (1.5) | (1.5) |
| Example 2-14 | 100 nm Ba-1 | 30 nm H—SiO₂ | 55 nm P—SiO₂ | 80 nm St-TiO₂ |
| | (2.5) | (2.5) | (4.5) | (1.5) |
| Example 2-15 | 100 nm Ba-1 | 30 nm H—SiO₂ | 55 nm P—SiO₂ | 80 nm St-TiO₂ |
| | (2.5) | (2.5) | (1.5) | (4.5) |
| Comparative | — | 30 nm SiO₂ | 55 nm SiO₂ | 80 nm TiO₂ |
| Example 2-1 | | (2.5) | (1.5) | (1.5) |
| Comparative | — | 30 nm H—SiO₂ | 55 nm P—SiO₂ | 80 nm St-TiO₂ |
| Example 2-2 | | (2.5) | (1.5) | (1.5) |
| Comparative | 100 nm Ba-2 | 30 nm H—SiO₂ | 55 nm P—SiO₂ | 80 nm St-TiO₂ |
| Example 2-3 | (2.5) | (2.5) | (1.5) | (1.5) |
| Comparative | 100 nm Ba-3 | 30 nm H—SiO₂ | 55 nm P—SiO₂ | 80 nm St-TiO₂ |
| Example 2-4 | (2.5) | (2.5) | (1.5) | (1.5) |
| Comparative | 100 nm Ba-4 | 30 nm H—SiO₂ | 55 nm P—SiO₂ | 80 nm St-TiO₂ |
| Example 2-5 | (2.5) | (2.5) | (1.5) | (1.5) |
| Comparative | 40 nm Ba-5 | 30 nm H—SiO₂ | 55 nm P—SiO₂ | 80 nm St-TiO₂ |
| Example 2-6 | (2.5) | (2.5) | (1.5) | (1.5) |
| Comparative | 160 nm Ba-6 | 30 nm H—SiO₂ | 55 nm P—SiO₂ | 80 nm St-TiO₂ |
| Example 2-7 | (2.5) | (2.5) | (1.5) | (1.5) |

<Property Evaluation Test>

Properties of each of the non-magnetic, mono-component toners prepared according to the examples and comparative examples were measured using the following process. Image density, charge stability, long term stability, and contamination of a charging roller were measured after printing 5,000 sheets of paper using a non-magnetic, mono-component developing type printer (HP 4600, Hewlett-Packard) including a tandem-type developing device using color toner under constant temperature/humidity conditions (25/55% RH) according to the following process.

(1) Image density (ID): Image density (ID) of solid area image was measured using a Macbeth color reflection densitometer, SpectroEye, and the results were classified into grades A, B, C and D as follows:

A: average image density of 1.4 or higher

B: average image density ranging from 1.3 to 1.4

C: average image density ranging from 1.2 to 1.3

D: average image density of 1.2 of less

(2) Charge stability (%): The charge amount was measured using a Suction Charge Analyzer, and the results were compared with the initial charge amount to evaluate charge stability. The results were classified into grades A, B, C and D as follows:

A: charge stability of 95% or higher

B: charge stability ranging from 85% to 95%

C: charge stability ranging from 75% to 85%

D: charge stability ranging from 50% to 75%

(When the charge stability is less than 50%, the image is not printed.)

(3) Long term stability:

Long term stability was determined by the following criteria using image density and charge stability measured using the previously described methods. The results were classified into grades A, B, C and D as follows:

A: image density of 1.4 or higher, and charge stability of 75% or higher

B: image density ranging from 1.3 to 1.4, and charge stability ranging from 70% to 75%

C: image density ranging from 1.2 to 1.3, and charge stability ranging from 60% to 70%

D: image density of less than 1.2, and charge stability ranging from 40% to 60%

(4) Contamination of charging roller

After printing 5,000 sheets of paper, the printer was disassembled, and contamination of a charging roller by toner was observed with the naked eyes.

O: no contamination

X: contamination

The image density, charge stability, long term stability, and contamination of a charging roller were evaluated based on the standards described above and the results are shown in Table 4 below.

TABLE 4

| | | | | | Long | Contam- |
|---|---|---|---|---|---|---|
| | | | | | term | ination |
| Examples and | Image | | | | sta- | of |
| Comparative | density | | Charge stability | | bility, | charging |
| Examples | Density | Grade | % | Grade | Grade | roller |
| Example 1-1 | 1.42 | A | 95.1 | A | A | X |
| Example 1-2 | 1.43 | A | 95.3 | A | A | X |
| Example 1-3 | 1.61 | A | 97.0 | A | A | X |
| Example 1-4 | 1.80 | A | 98.4 | A | A | X |
| Example 1-5 | 1.74 | A | 98.0 | A | A | X |
| Example 1-6 | 1.75 | A | 98.1 | A | A | X |
| Example 1-7 | 1.77 | A | 97.5 | A | A | X |
| Example 1-8 | 1.77 | A | 97.6 | A | A | X |
| Example 1-9 | 1.76 | A | 97.7 | A | A | X |
| Example 1-10 | 1.77 | A | 97.6 | A | A | X |
| Example 1-11 | 1.78 | A | 97.9 | A | A | X |
| Example 1-12 | 1.78 | A | 97.9 | A | A | X |
| Example 1-13 | 1.77 | A | 98.0 | A | A | X |
| Example 1-14 | 1.77 | A | 98.1 | A | A | X |
| Example 1-15 | 1.78 | A | 98.3 | A | A | X |
| Comparative | 1.13 | D | 51.0 | D | D | X |
| Example 1-1 | | | | | | |
| Comparative | 1.25 | C | 67.2 | C | C | X |
| Example 1-2 | | | | | | |
| Comparative | 1.10 | B | 57.4 | C | B | ◯ |
| Example 1-3 | | | | | | |
| Comparative | 1.16 | B | 60.6 | D | B | ◯ |
| Example 1-4 | | | | | | |
| Comparative | 1.12 | B | 58.9 | D | B | ◯ |
| Example 1-5 | | | | | | |
| Comparative | 1.10 | D | 50.2 | D | D | ◯ |
| Example 1-6 | | | | | | |
| Comparative | 0.86 | D | 46.5 | D | D | ◯ |
| Example 1-7 | | | | | | |
| Example 2-1 | 1.42 | A | 95.1 | A | A | X |
| Example 2-2 | 1.43 | A | 95.3 | A | A | X |
| Example 2-3 | 1.61 | A | 97.0 | A | A | X |
| Example 2-4 | 1.80 | A | 98.4 | A | A | X |
| Example 2-5 | 1.74 | A | 98.0 | A | A | X |
| Example 2-6 | 1.75 | A | 98.1 | A | A | X |
| Example 2-7 | 1.77 | A | 97.5 | A | A | X |
| Example 2-8 | 1.77 | A | 97.6 | A | A | X |
| Example 2-9 | 1.76 | A | 97.7 | A | A | X |
| Example 2-10 | 1.77 | A | 97.6 | A | A | X |
| Example 2-11 | 1.78 | A | 97.9 | A | A | X |
| Example 2-12 | 1.78 | A | 97.9 | A | A | X |
| Example 2-13 | 1.77 | A | 98.0 | A | A | X |
| Example 2-14 | 1.77 | A | 98.1 | A | A | X |
| Example 2-15 | 1.78 | A | 98.3 | A | A | X |
| Comparative | 1.16 | D | 63.5 | D | D | X |
| Example 2-1 | | | | | | |
| Comparative | 1.12 | C | 54.9 | C | C | X |
| Example 2-2 | | | | | | |
| Comparative | 1.03 | B | 46.8 | C | B | ◯ |
| Example 2-3 | | | | | | |
| Comparative | 1.06 | B | 49.8 | B | B | ◯ |
| Example 2-4 | | | | | | |
| Comparative | 1.10 | B | 50.8 | B | B | ◯ |
| Example 2-5 | | | | | | |
| Comparative | 0.96 | D | 49.5 | D | D | ◯ |
| Example 2-6 | | | | | | |
| Comparative | 0.85 | D | 43.2 | D | D | ◯ |
| Example 2-7 | | | | | | |

As shown in Table 4 above, toner having excellent image density, charge stability, and long term stability can be prepared by using a spherical barium titanate external additive, particularly, by using a barium titanate external additive together with silica surface-treated with HMDS or PDMS and having different particle diameters (supplementary external additives A and B) and titanium dioxide surface-treated with strontium (supplementary external additive C). That is, as the external additive particles become closer to spherical in shape, the original spherical shape of the external additive particle can be maintained even though the external additives are attached to the parent toner particles. The external additives can function as spacers, and thus detachment of the external additives from the parent toner particles can be reduced when the toners collide with each other. In addition, charge stability may be improved and mobility of toner may not be changed by uniformly attaching the external additives to the parent toner particles. Thus, a sharp charge distribution can be obtained so that high image quality can be stably maintained for a long period of time.

Furthermore, toner prepared according to the comparative examples seriously contaminates a charging roller of a developing device, but toner prepared according to embodiments of the present invention does not contaminate the charging roller in the developing device.

While the present invention has been particularly shown and described with reference to exemplary embodiments thereof, it will be understood by one of ordinary skill in the art that various changes in form and details may be made therein without departing from the spirit and scope of the present invention as defined by the following claims.

1. An electrophotographic toner comprising:
parent toner particles comprising a binder resin, a colorant, a releasing agent, and a charge control agent; and
barium titanate external additives having an average primary particle diameter in a range of about 50 to about 150 nm, an average shape factor (SF1) in a range of about 100 to about 120, a shape factor in a range of about 0.96 to about 1, and an aspect ratio in a range of about 0.89 to about 1, and added to the surface of the parent toner particles.

2. The electrophotographic toner of claim 1, wherein the amount of the barium titanate external additives is in a range of about 0.3 to about 5 parts by weight based on 100 parts by weight of the parent toner particles.

3. The electrophotographic toner of claim 1, further comprising:
a supplementary external additive A in the form of silica having an average primary particle diameter in a range of about 5 to about 50 nm and surface-treated with hexamethyl disilazane (HMDS); and
a supplementary external additive B in the form of silica having an average primary particle diameter in a range of about 30 to about 80 nm and surface-treated with polydimethyl siloxane (PDMS), as external additives.

4. The electrophotographic toner of claim 3, further comprising a supplementary external additive C in the form of an inorganic compound having an average primary particle diameter in the range of about 10 to about 100 nm.

5. The electrophotographic toner of claim 4, wherein the amount of the supplementary external additive A is in the range of about 0.5 to about 5 parts by weight; the amount of the supplementary external additive B is in the range of about 0.1 to about 3 parts by weight; and the amount of the supplementary external additive C is in the range of about 0.1 to about 3 parts by weight, based on 100 parts by weight of the parent toner particles.

6. The electrophotographic toner of claim 1, wherein the parent toner particles have a shape factor in the range of about 0.975 to about 1 and a volume average particle diameter in the range of about 5 to about 7 μm.

7. An electrophotographic image forming apparatus employing an electrophotographic toner according to claim 1.
